(19) United States
(12) Patent Application Publication
(10) Pub. No.: US 2022/0372598 A1
(43) Pub. Date: Nov. 24, 2022

(54) ALUMINUM ALLOY MATERIAL

(71) Applicant: SUMITOMO ELECTRIC INDUSTRIES, LTD., Osaka-shi, Osaka (JP)

(72) Inventors: Toru MAEDA, Osaka-shi (JP); Rui IWASAKI, Osaka-shi (JP)

(73) Assignee: SUMITOMO ELECTRIC INDUSTRIES, LTD., Osaka-shi, Osaka (JP)

(21) Appl. No.: 17/762,888

(22) PCT Filed: Mar. 22, 2021
(86) PCT No.: PCT/JP2021/011736

§ 371 Date: Mar. 23, 2022

(30) Foreign Application Priority Data
Apr. 17, 2020 (JP) 2020-073805

(51) Int. Cl. C22C 21/00; C22C 1/04

(52) U.S. Cl. CPC C22C 21/00; C22C 1/0416

(57) ABSTRACT

An aluminum alloy material comprising a composition containing no less than 1.2 at % and no more than 6.5 at % of Fe, no less than 0.15 at % and no more than 5 at % of at least one first element selected from the group consisting of Nd, W, and Sc, and no less than 0.005 at % and no more than 2 at % of at least one second element selected from the group consisting of C and B, the balance being Al and inevitable impurities.

### TECHNICAL FIELD

The present disclosure relates to an aluminum alloy material.

The present application claims priority based on Japanese Patent Application No. 2020-073805, filed on Apr. 17, 2020, and the contents of the Japanese Patent Application are incorporated herein by reference in its entirety.

### BACKGROUND ART

PTL 1 and PTL 2 disclose an aluminum alloy including Fe or Ni, and Nd in a specific range. PTL 1 discloses a ribbon alloy having a thickness of 20 μm. PTL 2 discloses wire rod having a wire size of 0.5 mm. Note that Fe is iron; Ni is nickel; and Nd is neodymium.

### CITATION LIST

### Patent Literature

PTL 1: Japanese Patent Laying-Open No. 06-256878
PTL 2: WO 2019/135372

### SUMMARY OF INVENTION

The aluminum alloy material of the present disclosure comprises a composition containing no less than 1.2 at % and no more than 6.5 at % of Fe, no less than 0.15 at % and no more than 5 at % of at least one first element selected from the group consisting of Nd, W, and Sc, and no less than 0.005 at % and no more than 2 at % of at least one second element selected from the group consisting of C and B, the balance being Al and inevitable impurities.

In the present disclosure, Fe is iron; Nd is neodymium; W is tungsten; Sc is scandium; C is carbon; B is boron; and Al is aluminum. In the following description, element names may be indicated by element symbols.

### BRIEF DESCRIPTION OF DRAWINGS

FIG. 1 is an image showing one example of a photograph for a cross section of an aluminum alloy material observed with a scanning electron microscopy in an embodiment.

FIG. 2 is a diagram that illustrates a method of measuring the maximum length of a compound including Al and Fe.

### DETAILED DESCRIPTION

### Problem to be Solved by the Present Disclosure

An aluminum alloy material having excellent proof stress is desired.

There is a growing need to use an aluminum alloy as a constituent material of conductive members such as spring contacts for the purpose of measures against electrolytic corrosion, weight reduction, cost reduction, and the like. However, the proof stress of an aluminum alloy is lower than that of copper alloys such as phosphor bronze and Corson copper. Therefore, enhancement of proof stress of aluminum alloys is desired in order to make practical use of spring contacts or the like formed of the aluminum alloys.

In addition, aluminum alloys have inferior heat resistance compared to, for example, the above copper alloys. The temperature in conductive members such as spring contacts rises as current is applied during use. Therefore, excellent heat resistance is preferable because it increases the long-term reliability of the conductive members.

PTL 1 discloses that the above-mentioned ribbon alloy has high tensile fracture strength. However, when a bulk material is produced by performing hot pressing followed by hot extrusion using the ribbon alloy as described in PTL 1, the tensile fracture strength significantly decreases. The 0.2% proof strength also results in a low value for tensile fracture strength, similar to other aluminum alloys. The above-mentioned bulk material produced by hot extrusion has a structure in which Fe that has formed a solid solution in the parent phase is precipitated as a compound including Al, which differs from a structure of a ribbon alloy in which Fe forms a solid solution in the parent phase. Therefore, the strength enhancement effect by solid solution strengthening of Fe cannot be obtained in the hot extruded material. In the hot extruded material, the strength enhancement effect by dispersion strengthening of the compound is presumed to be small compared to the loss of solid solution strengthening of Fe. PTL 1 also discloses in FIG. 6 that when an Al—Ni—Nd alloy is heated at a temperature exceeding about 500 K, the tensile fracture strength dramatically decreases. From these facts, even if the bulk material is prepared through hot extrusion and heat treatment using the ribbon alloy described in PTL 1, this bulk material is presumed to be inferior in strength and proof stress.

Accordingly, one of the purposes of the present disclosure is to provide an aluminum alloy material having excellent proof stress.

### Advantageous Effect of the Present Disclosure

The aluminum alloy material of the present disclosure has excellent proof stress.

### DESCRIPTION OF EMBODIMENTS

First, embodiments of the present disclosure will be listed and described.

(1) An aluminum alloy material according to one aspect of the present disclosure comprises a composition containing no less than 1.2 at % and no more than 6.5 at % of Fe, no less than 0.15 at % and no more than 5 at % of at least one first element selected from the group consisting of Nd, W, and Sc, and no less than 0.005 at % and no more than 2 at % of at least one second element selected from the group consisting of C and B, the balance being Al and inevitable impurities.

The aluminum alloy material of the present disclosure comprises the above-mentioned specific composition, thereby having excellent proof stress as described below. Details of the first element and the second element will be described later.

The aluminum alloy material of the present disclosure typically has a structure in which fine particles formed of a compound including Al and Fe are dispersed in the fine crystal structure. The structure is specifically described later in (2). The first element is presumed to have a stabilizing effect on the particle composed of the compound. The second element is presumed to have an inhibiting effect on the growth of the compound by inhibiting atomic diffusion of Al and Fe constituting the compound. In other words, the second element is presumed to prevent the compound from becoming coarse. If the compound is dispersed in the parent phase in a fine state, the fine particles of the compound inhibits plastic deformation of the soft Al-based parent phase. As a result, the second element inhibits the migration of dislocations in the parent phase. Such aluminum alloy material of the present disclosure has high 0.2% proof stress at room temperature, for example, 25° C. The aluminum alloy material of the present disclosure also has high tensile strength at room temperature.

Furthermore, the first element is presumed to contribute to enhancement of heat resistance by including the first element in the above range. Therefore, the above-mentioned fine structure is easily maintained even at high temperature, for example, 250° C. Such aluminum alloy material of the present disclosure is easily to have high tensile strength even at the above high temperature. From this point, the aluminum alloy material of the present disclosure also has excellent heat resistance.

(2) One example of the aluminum alloy material of the present disclosure includes an example in which the material comprises a structure including a parent phase including no less than 99 at % of Al, and particles that are present in the parent phase and formed of a compound including Al and Fe; and has in a cross section, crystal grains constituting the parent phase that have an average grain size of no more than 1,700 nm, and the particles that have an average length of no more than 140 nm.

Hereinafter, a particle composed of a compound including Al and Fe may be referred to as a compound particle.

The average grain size of the crystal grains and the average length of the compound particles is the size measured in any cross section of the aluminum alloy material. Details of a method of measuring the average grain size and the average length will be described later in Test Example 1.

The aluminum alloy material of the example can better obtain an inhibitory effect on the migration of dislocations in the above-mentioned parent phase by the fine compound particles. The aluminum alloy material of the example can also better obtain an enhancement effect on mechanical strength through dispersion strengthening by the fine compound particles and through grain boundary strengthening by fine crystal grains. Furthermore, the fine compound particles do not easily become a starting point of cracking. From these points, the aluminum alloy material of the example has excellent proof stress and strength at room temperature. As mentioned above, the fine structure is easily maintained even at high temperature. Therefore, the aluminum alloy material of the example also has excellent heat resistance.

The compound particles do not easily become starting point of cracking. From this point, the example is also excellent in elongation at room temperature. Further, the fine compound particles do not easily interfere with a conductive path of Al. From this point, the example is also excellent in conductive properties.

(3) One example of the aluminum alloy material in (2) includes an example in which the particles has an aspect ratio of no more than 3.5.

Details of a method of measuring the aspect ratio will be described later in Test Example 1.

Compound particles having an aspect ratio of no more than 3.5 are almost spherical in shape. Such compound particles are easily dispersed in a uniform manner.

Such compound particles do not easily become a starting point of cracking. Such compound particles further do not easily interfere with the conductive path of Al.

(4) One example of the aluminum alloy material of the present disclosure includes an example in which the material has a tensile strength of no less than 275 MPa at 25° C.

The aluminum alloy material of the example has high tensile strength at room temperature. Such aluminum alloy material has high 0.2% proof stress at room temperature and thus is excellent in proof stress.

(5) One example of the aluminum alloy material of the present disclosure includes an example in which a 0.2% proof stress value at 25° C. is no less than 70% of a tensile strength value at 25° C.

The aluminum alloy material of the example has high 0.2% proof stress at room temperature.

(6) One example of the aluminum alloy material of the present disclosure includes an example in which a rate of reduction in tensile strength, as determined from the tensile strength value at 25° C. and the tensile strength value at 250° C., is no more than 0.30%/° C.

In the aluminum alloy material of the example, the tensile strength does not easily decrease even at high temperature such as 250° C. Such aluminum alloy material is excellent in heat resistance.

(7) One example of the aluminum alloy material of the present disclosure includes an example in which elongation after fracture at 25° C. is no less than 3%.

The aluminum alloy material of the example has not only excellent proof stress at room temperature but also excellent elongation. Such aluminum alloy material is suitable as a constituent material of conductive members such as spring contacts and the like.

(8) One example of the aluminum alloy material of the present disclosure includes an example in which the material has a conductivity of no less than 25% IACS at 25° C.

The aluminum alloy material of the example has not only excellent proof stress at room temperature but also excellent conductive properties. Such aluminum alloy material is suitable as a constituent material of conductive members such as spring contacts and the like.

### DETAILS OF EMBODIMENTS OF THE PRESENT DISCLOSURE

Hereinafter, embodiments of the present disclosure will be described in detail.

[Aluminum Alloy Material]

### SUMMARY

The aluminum alloy material of an embodiment is a formed product made of an aluminum alloy based on aluminum. The aluminum alloy includes iron and the following first and second elements as additive elements. Specifically, the aluminum alloy material of the embodiment comprises a composition containing no less than 1.2 at % and no more than 6.5 at % of iron, no less than 0.15 at % and no more than 5 at % of the first element, and no less than 0.005 at % and no more than 2 at % of the second element, the balance being aluminum and inevitable impurities.

The first element is at least one metallic element selected from the group of neodymium, tungsten, and scandium.

The second element is at least one non-metallic element selected from the group of carbon and boron.

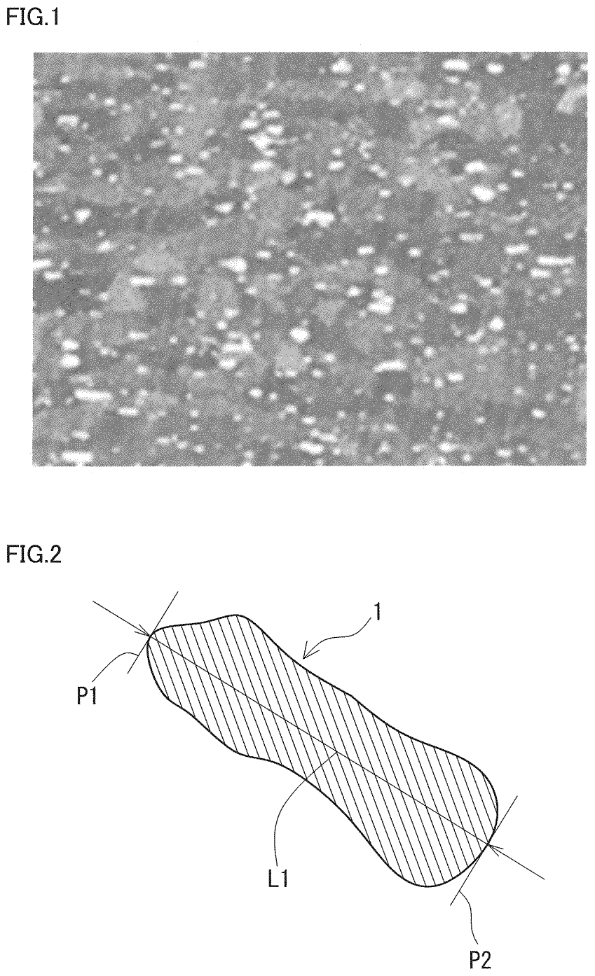

The aluminum alloy material of the embodiment typically has the structure as follows. In the structure as shown in FIG. 1, the Al-based parent phase is formed of fine crystals, while fine particles formed of a compound including Fe and Al are dispersed in the parent phase. In FIG. 1, black and gray particles are crystal grains constituting the parent phase. In FIG. 1, white particles are particles composed of the compound including Fe and Al. In particular, the fine compound particles can obtain an inhibiting effect on plastic deformation of the soft parent phase by including the second element in the above range. This effect allows the aluminum alloy material of the embodiment to be excellent in proof stress. The aluminum alloy material of the embodiment is also excellent in heat resistance by including the first element in the above range.

Hereinafter, the present invention will be described in detail.

(Composition)

<Fe>

Fe satisfies the following conditions (T) to (III).

(I) In terms of the limit of solid solution to Al in the equilibrium state, the limit of solid solution under the condition of 500° C. and 1 atm is no more than 0.25 at %.
(II) In terms of the limit of solid solution to Al in the equilibrium state, the limit of solid solution under the condition of 950° C. and 1 atm is no less than 6.5 at %.
(III) Fe forms a compound with Al.

Among binary intermetallic compounds of Al and Fe, a compound with the lowest element ratio of Fe, such as Al₁₃Fe₄, has a melting point of no less than 1,100° C. Therefore, the compound is excellent in stability at high temperature such as 250° C.

In the process of producing the aluminum alloy material of the embodiment, molten aluminum alloy including Fe in the above-mentioned range is prepared at a temperature of, for example, no less than 950° C. When this molten metal is solidified at a cooling rate of, for example, no less than 1×10⁵° C./sec, an aluminum alloy in which Fe forms a solid solution is obtained. When this aluminum alloy in which Fe forms a solid solution is heated to a temperature at which Fe can be precipitated, Fe that has formed a solid solution becomes a compound including Al and Fe and is precipitates in the parent phase. The precipitated compound is dispersed in the parent phase. In the aluminum alloy material of the embodiment, dispersion strengthening by this compound particle can be used as one of the strengthening structures of the alloy. Note that the “aluminum alloy in which Fe forms a solid solution” here includes a state in which the compound including Al and Fe precipitates as fine particles of less than 10 nm.

If the content of Fe is no less than 1.2 at %, the amount of compound particles is easily increased. Therefore, the strength enhancement effect can be better obtained by dispersion strengthening of the compound particle. Such an aluminum alloy materials of the embodiment has excellent strength and proof stress at room temperature, compared to the case where the content of Fe is less than 1.2 at % and Fe mainly forms a solid solution. In addition, the heat resistance is improved. The higher the content of Fe, the higher the strength and proof stress at room temperature and the higher heat resistance. From the viewpoint of the enhancement of proof stress, heat resistance, or the like, the content of Fe may be no less than 1.4 at %, no less than 1.5 at %, and no less than 2.0 at %. Further, the content of Fe may be no less than 2.5 at % and no less than 3.0 at %.

If the content of Fe is no more than 6.5 at %, the compound including Al and Fe does not easily grow into a coarse, needle-like particle, but becomes fine. If the compound is fine, the following effects (i) to (v) are easily obtained.

(i) The strength enhancement effect by dispersion strengthening of the fine compound particles is easily obtained.

(ii) The fine compound particles is easily inhibit the growth of crystals constituting the parent phase. Therefore, the crystals easily become fine. If the crystals are fine, the strength enhancement effect by grain boundary strengthening is easily obtained.

(iii) Embrittlement of the aluminum alloy by coarse compound particles is easily inhibited.

(iv) Stress is less concentrated on the fine compound particles. Therefore, the fine compound particles do not easily become a starting point of cracking.

(v) The fine compound particles do not easily interfere with the conductive path of Al that constitutes the parent phase.

The aluminum alloy material of the embodiment has excellent strength and proof stress at room temperature, especially by the effects (i) to (iv). As described later, the above-mentioned fine structure is easily maintained even at high temperature. Therefore, the aluminum alloy material of the embodiment is also excellent in heat resistance. Furthermore, the aluminum alloy material of the embodiment is also excellent in elongation, especially by the effect (iv). Therefore, the aluminum alloy material of the embodiment is easily bent. The aluminum alloy material of the embodiment is excellent in conductive properties, especially by the effect (v). If the content of Fe is in the above range, the conductive path of Al is not easily interfered with, because the amount of compound particles is appropriate. In addition, the amount of solid solution of Fe to Al is small because Fe is a compound. From these points, conductive properties are also improved. Since these effects can be better obtained, the content of Fe may be no more than 6.2 at % and even no more than 6.0 at %.

The aluminum alloy material of the embodiment in which the content of Fe is no less than 1.4 at % and no more than 6.2 at %, and no less than 1.5 at % and no more than 6.0 at % at has not only excellent strength, proof stress, and heat resistance at room temperature but also toughness and conductive properties.

<First Element>

The first element is presumed to be present by being included mainly in a compound including Al and Fe. The first element also presumed to promote the generation of fine precipitation nuclei for the compound. Therefore, the compound is easily precipitated in a fine scale. In addition, the first element is presumed to have a stabilizing effect on the compound. Although the details of the stabilization mechanism are not known, the calculation of a state diagram indicates that the compound becomes thermodynamically stable. The initial generation of the compound is stable at a fine size, preventing neighboring compounds from coalescing with each other. The coalescence that makes the compound coarse is presumed to be inhibited. As a result of the stabilization effect described above, the compound is presumed not to easily become coarse even when hot working, heat treatment and the like are performed in the production process as described later. Furthermore, the compound including the first element has better heat resistance than the intermetallic compound of Al and Fe that does not include the first element. Therefore, even if the aluminum alloy material reaches a high temperature, for example 250° C., during use, the compound does not easily become coarse, and thus easily maintains a fine state. Therefore, the above-mentioned effects (i) to (v) are easily obtained even at the above high temperature.

If the content of the first element is no less than 0.15 at %, a compound including Al and Fe is easily stabilized and thus does not easily become coarse. The higher content of the first element prevents the compound from becoming coarse, so that the compound is fine. Therefore, the above-mentioned effects (i) to (v) are easily obtained. As a result, the aluminum alloy material of the embodiment has not only excellent strength and proof stress at room temperature but also heat resistance. In addition, the aluminum alloy material of the embodiment is excellent in elongation and conductive properties. Since these effects can be better obtained, the content of the first element may be no less than 0.18 at %, or no less than 0.20 at %.

If the content of the first element is no more than 5 at %, the aluminum alloy material of the embodiment has excellent strength and proof stress at room temperature, while the reduction in elongation and conductivity is inhibited. One of the reasons for this is that precipitates with relatively low melting points are not easily generated. As the content of the first element increases, compounds with relatively low melting points are easily precipitated as compounds other than those including Al and Fe. The compounds with relatively low melting points easily become coarse. Coarse compounds may become a starting point of cracking or interfere with the conductive path of Al. From the viewpoint of good elongation and good conductive properties, the content of the first element may be no more than 3.0 at %, no more than 2.0 at %, and no more than 1.5 at %. Further, the content of the first element may be no more than 1.0 at %, no more than 0.8 at %, no more than 0.5 at %.

If the content of the first element is no less than 0.18 at % and no more than 3.0 at/o, the aluminum alloy material of the embodiment has not only excellent strength, proof stress, and heat resistance at room temperature but also excellent toughness and conductive properties.

The aluminum alloy material of the embodiment may include only one element among Nd, W, and Sc as the first element or may include two elements or three elements. When two elements or three elements are included, the above-mentioned content of the first element is the total amount.

Among the first elements, the order in which the stabilization effect or the like of the compound including Al and Fe is easily obtained is estimated from test examples described later as follows. When the second element described below is C, the order in which the stabilization effect or the like is easily obtained is W, next Nd, and then Sc.

In other words, when the second element is C, W is estimated to be the easiest to obtain the stabilization effect. When the second element is B, the order in which the stabilization effect or the like is easily obtained is Sc, next Nd, and then W. In other words, when the second element is B, Sc is estimated to be the easiest to obtain the stabilization effect.

The atomic radius of the first element is larger than the atomic radius of the second element described later. Therefore, the first element is presumed to contribute to the atoms of the second element that may easily get into the parent phase.

Moreover, the aluminum alloy material of the embodiment in which the first element is Nd or Sc is also excellent in manufacturability. The reason for this is that the melting point of Nd is lower than that of Fe, thereby making it easier to obtain the molten metal in the production process and that the melting point of Sc is close to that of Fe, thereby making it easier to obtain the molten metal in the production process. The low eutectic temperature of Al and Nd or Sc is also advantageous for production.

Note that in the aluminum alloy material of the embodiment, some of the first elements are allowed to be present as compounds including Al but not including Fe. The compounds including Al but not including Fe typically include intermetallic compounds of the first element and Al. Examples of intermetallic compounds between the first element and Al include Al₄Nd, Al₃Sc, and Al₁₂W. These intermetallic compounds have a melting point exceeding 1,100° C. and are higher than the melting point of the binary intermetallic compounds of the above-mentioned Al and Fe. Therefore, the intermetallic compounds of the first element and Al are presumed to contribute to the enhancement of heat resistance. In addition, the high melting point makes the intermetallic compounds of the first element and Al stable as precipitates compared to the binary intermetallic compounds of Al and Fe. The strength enhancement effect by precipitation strengthening is expected to result from the precipitation of the intermetallic compounds of the first element and Al.

<Second Element>

The second element is presumed to be present mainly as extremely fine carbides or borides around the compound including Al and Fe or inside the compound. The carbides or the borides are presumed to have an inhibiting effect on the atomic diffusion of Al and Fe constituting the compound. The inhibition of the atomic diffusion is presumed to easily inhibit the neighboring compounds from coalescing with each other and making the compounds coarse, and especially inhibit their needle-like growth. If the compounds including Al and Fe are fine, the above-mentioned effects (i) to (v) can be obtained. In addition, even when large plastic deformation is performed under heated conditions in the production process, such as hot extrusion, the compound is easily maintained in a fine state. Therefore, finally, a texture in which the compound is fine is easily obtained. The fine compound easily inhibits the migration of dislocations in the above-mentioned parent phase. In an aluminum alloy material including the first element in the above range but not including the second element, the inhibitory effect of the migration of dislocations cannot be obtained. Therefore, the aluminum alloy material including the first element in the above range but not including the second element is presumed to be inferior in proof stress compared to the aluminum alloy material of the embodiment.

Alternatively, some of the second elements are presumed to form a solid solution in the parent phase. If the second elements form a solid solution in the parent phase, the strength enhancement effect by solid solution strengthening is presumed to be obtained.

If the content of the second element is no less than 0.005 at %, the above-mentioned effects (i) to (v) by the fineness of the compound including Al and Fe are easily obtained. The strength enhancement effect by solid solution strengthening is also obtained. Therefore, the aluminum alloy material of the embodiment has not only excellent strength and proof stress at room temperature but also excellent heat resistance. The aluminum alloy material of the embodiment is also excellent in elongation and conductive properties. Since these effects can be better obtained, the content of the second element may be no less than 0.01 at %, no less than 0.03 at %, and no less than 0.05 at %.

If the content of the second element is no more than 2 at %, the aluminum alloy material of the embodiment has excellent strength and proof stress at room temperature strength, while the reduction in elongation and conductivity is inhibited. From the viewpoint of good elongation and good conductive properties, the content of the second element may be no more than 1.5 at %, no more than 1.2 at %, and no more than 1.0 at %. Furthermore, the total amount of the second element may be no more than 0.5 at % and no more than 0.1 at %.

The aluminum alloy material of the embodiment in which the content of the second element is no less than 0.01 at % and no more than 1.5 at %, and no less than 0.03 at % and no more than 1.2 at % has excellent strength, proof stress, and heat resistance at room temperature but also excellent toughness and conductive properties.

The aluminum alloy material of the embodiment may include only one element of C and B as the second element or may include two elements. When two elements are included, the above-mentioned content of the second element is the total amount.

An aluminum alloy material including only B among the second elements tends to be superior in strength, proof stress, and heat resistance compared to those including only C. An aluminum alloy material including only C among the second elements tends to have a higher improvement effect on toughness than those including only B. An aluminum alloy material including both C and B is expected to easily have strength, proof stress, heat resistance, and toughness in good balance.

Moreover, Al and Fe, the first element, and the second element have different melting points and reactivity to acids and the like. Thus, Al and Fe, the first element, and the second element can be separated. The melting point of Fe is no less than 800° C. higher than the melting point of Al. Therefore, Al and Fe can be separated. From these points, the aluminum alloy material of the embodiment is also excellent in recyclability.

<Other>

The content of Fe, the content of the first element, and the content of the second element here are atom ratios when taking an aluminum alloy constituting an aluminum alloy material as 100 at %. The content of each element is the amount included in the aluminum alloy. If raw materials include Fe, the first element, and the second element as impurities in the production process, the amount of Fe and other elements added to the raw materials is adjusted so that the content of these Fe and other elements meets the above-mentioned range.

(Texture)

The aluminum alloy material of the embodiment comprises, for example, a parent phase including no less than 99 at % of Al and particles composed of a compound including Al and Fe. The compound particles are present in the parent phase. As shown in FIG. 1. the compound particles are dispersed in the parent phase. In the aluminum alloy material of the embodiment, in a cross section, crystal grains constituting the parent phase have an average grain size of no more than 1,700 nm. In the cross section, the compound particles have an average length of no more than 140 nm.

<Parent Phase>

In the aluminum alloy material of the embodiment, the parent phase is the main phase, excluding precipitates such as compounds including Al and Fe. Taking the parent phase as 100 at %, if the content of Al in the parent phase is no less than 99 at %, the amount of solid solution of Fe and other additive elements to Al is small. Fe in the aluminum alloy material is substantially present as the compound. Such aluminum alloy material of the embodiment can better obtain a strength enhancement effect by dispersion strengthening of the compound particles. As a result, the strength and proof stress at room temperature are improved. In addition, the heat resistance is also improved. Furthermore, the small amount of solid solution of Fe and the like also results in improved conductive properties. The higher the content of Al in the parent phase, the smaller the amount of solid solution of Fe or the like and the more appropriately the compound particle are present. Therefore, since the above-mentioned effects are easily obtained, the content of Al in the parent phase may be no less than 99.2 at % and no less than 99.5 at %. The amount of additive elements such as Fe, production conditions, and the like are adjusted so that the content of Al in the parent phase is in the predetermined range.

<Crystal Grain>

In any cross section of the aluminum alloy material of the embodiment, if the crystal grains of the parent phase have an average grain size of no more than 1,700 nm, the crystals are small. Small crystals result in more crystal grain boundaries. With more crystal grain boundaries, slip surfaces easily become discontinuous via the grain boundaries. Therefore, the resistance to slip is improved. The enhancement of this resistance strengthens the grain boundaries. In the aluminum alloy material of the embodiment in which the parent phase consists of the fine crystal texture as described above, grain boundary strengthening can be used as one of strengthening structures of the alloy.

The average grain size of crystals of the parent phase here is an average of grain sizes of a plurality of crystal grains, taking the diameter of the circle having an area equivalent to the cross-sectional area of the crystal grains in the above-mentioned cross section as the grain size of the crystal grains. Details of the measurement method will be described in Test Example 1.

The smaller the average grain size of the crystal grains of the parent phase, the more easily the strength enhancement effect by grain boundary strengthening can be obtained. In addition, the smaller the crystals, the more easily the fine compound particles are dispersed in the parent phase in a uniform manner. Therefore, the strength enhancement effect by dispersion strengthening of the fine compound particles is easily obtained. These strength enhancement effects improve strength and proof stress at room temperature. In addition, the heat resistance is improved. From the viewpoint of enhancement of strength, proof stress, and heat resistance, the average grain size may be no more than 1,680 nm and no more than 1,650 nm.

If the crystal grains of the parent phase have an average grain size of no more than 1,600 nm, the strength enhancement effect by grain boundary strengthening is easily obtained. From the viewpoint of additional enhancement of strength, proof stress, and heat resistance, the average grain size may be no more than 1,550 nm and no more than 1,500 nm. Furthermore, the average grain size may be no more than 1,300 nm, no more than 1,200 nm, and no more than 1,000 nm.

There is no particular lower limit for the average grain size of the crystal grains of the parent phase. In consideration of manufacturability or the like, the average grain size includes, for example, no less than 200 nm and no less than 300 nm.

The aluminum alloy material of the embodiment in which the crystal grains of the parent phase have an average grain size of no less than 200 nm and no more than 1,700 nm, and no less than 300 nm and no more than 1,600 nm has not only excellent strength, proof stress, and heat resistance at room temperature but also excellent manufacturability.

<Compound Particle>

<<Size>>

In any cross section of the aluminum alloy material of the embodiment, compound particles having an average length of no more than 140 nm are not conterminous in the parent phase and are short or small. The fine compound particles are easily isolated in the parent phase, i.e., are easily dispersed. The dispersion strengthening by the fine compound particles improves strength and proof stress.

The average length of the compound particles here is the maximum length of the compound particles in the above-mentioned cross section. Details of the measurement method will be described in Test Example 1.

The shorter the average length of the compound particles, the above-mentioned effects (i) to (v) are easily obtained. As a result, the aluminum alloy material of the embodiment has not only excellent strength and proof stress at room temperature but also excellent heat resistance. The aluminum alloy material of the embodiment is also excellent in elongation and conductive properties. Since these effects can be better obtained, the average length may be no more than 135 nm, no more than 130 nm, and no more than 125 nm. Furthermore, the average length may be no more than 100 nm.

There is no particular lower limit for the average length of the compound particles. In consideration of manufacturability or the like, examples of the average length include no less than 10 nm and no less than 15 nm.

The aluminum alloy material of the embodiment in which the compound particles have an average length of no less than 10 nm and no more than 140 nm, and no less than 15 nm and no more than 135 nm has not only excellent strength, proof stress, and heat resistance at room temperature but also excellent toughness, conductive properties, and manufacturability.

Note that in the aluminum alloy material of the embodiment, the compound particles easily become fine even in the production process involving hot working, heat treatment, and the like. From this point, the high degree of freedom in production conditions also makes the aluminum alloy material of the embodiment excellent in manufacturability.

<<Shape>>

The shape of the compound particles is not an elongated shape such as a needle shape but an elliptical shape with a small difference between the major axis length and the minor axis length, and the more spherical shape is further preferable. The reasons for this include that the compound particles are easily dispersed in the parent phase in a uniform manner, the compound particles do not easily become a starting point of cracking by bending or the like, and that the compound particles do not easily interfere with the conductive path of Al. In the aluminum alloy material of the embodiment, the compound particles do not easily become needle-like, as mentioned above. As such, the compound particles easily become elliptical or spherical in shape. Examples of the aspect ratio of the compound particles include no more than 3.5.

The aspect ratio here is a ratio of the major axis length to the following minor axis length (major axis length/minor axis length) in the above-mentioned cross section. The major axis length is the maximum length of the compound particles. The minor axis length is the maximum length of the compound particles in the direction perpendicular to the major axis direction. Details of the measurement method will be described in Test Example 1.

The aluminum alloy material of the embodiment in which the compound particles have an aspect ratio of no more than 3.5 can obtain the following effects (i) to (iii). (i) The compound particles are easily dispersed in the parent phase in a uniform manner. (ii) The compound particles do not easily become a starting point of cracking. (iii) The compound particles do not easily interfere with the conductive path of Al.

Such the aluminum alloy material of the embodiment has not only excellent strength and proof stress at room temperature but also excellent heat resistance. The aluminum alloy material of the embodiment is also excellent in elongation and conductive properties. When the aspect ratio is closer to 1, the shape anisotropy is smaller or substantially absent, thus making it easier to obtain the above-mentioned three effects (i) to (iii). Therefore, the aspect ratio may be no less than 1 and no more than 3.3, no more than 3.0, and no more than 2.8. Furthermore, the aspect ratio is no less than 1 and no more than 2.5.

### <Relative Density>

The aluminum alloy material of the embodiment may have a relative density of no less than 90%, for example. Such a dense aluminum alloy material has fewer holes that can be a starting point of cracking. From this point, strength, proof stress, and heat resistance at room temperature are improved. Toughness is also easily improved. The relative density is preferably no less than 92%, no less than 95%, and no less than 98%.

The upper limit of the relative density is 100%. If the relative density is 100%, an aluminum alloy material has true density. The relative density is determined by (apparent density/true density)×100. The apparent density is determined by (mass/apparent volume). The mass of the aluminum alloy material is measured by an appropriate measuring apparatus. The apparent volume is a volume including voids or the like that may be present inside the aluminum alloy material. The true density is determined using the Bravais lattice density of substances constituting aluminum alloy material. Details of the true density will be described later in test examples.

<Mechanical Property>

<<Tensile Strength>>

One example of the aluminum alloy material of the embodiment includes that the material has a tensile strength of no less than 275 MPa at 25° C. If the tensile strength at room temperature, such as 25° C. is no less than 275 MPa, the 0.2% proof stress is easily improved at room temperature. In addition, even if the tensile strength decreases at high temperature, for example, 250° C., the aluminum alloy material easily has a certain high tensile strength. Such the aluminum alloy material of the embodiment has not only excellent strength and proof stress at room temperature but also excellent heat resistance.

The tensile strength at 25° C. may be no less than 280 MPa, no less than 300 MPa, and no less than 320 MPa. In this case, the aluminum alloy material of the embodiment is not only superior in strength and proof stress at room temperature but also superior in heat resistance. Furthermore, the tensile strength may be no less than 350 MPa, no less than 380 MPa, and no less than 400 MPa.

The aluminum alloy material of the embodiment in which the tensile strength at 25° C. is, for example, no less than 275 MPa and no more than 600 MPa, and no less than 280 MPa and no more than 580 MPa has excellent strength and proof stress at room temperature strength, while easily having high elongation.

<<0.2% Proof Stress>>

One example of the aluminum alloy material of the embodiment includes that the material has 0.2% proof stress of no less than 190 MPa at 25° C. If the 0.2% proof stress at room temperature is no less than 190 MPa, the aluminum alloy material of the embodiment has excellent proof stress at room temperature.

When the 0.2% proof stress at 25° C. is no less than 200 MPa, no less than 215 MPa, and no less than 220 MPa, the proof stress at room temperature is higher and preferable. The 0.2% proof stress may be no less than 250 MPa, no less than 280 MPa, and no less than 300 MPa.

The aluminum alloy material of the embodiment in which the 0.2% proof stress at 25° C. is, for example, no less than 190 MPa and no more than 550 MPa, and no less than 200 MPa and no more than 520 MPa has excellent proof stress at room temperature while easily having high elongation.

<<Value of 0.2% Proof Stress Relative to Value of Tensile Strength>>

One example of the aluminum alloy material of the embodiment includes that the 0.2% proof stress value at 25° C. is no less than 70% of the tensile strength value at 25° C. Hereinafter, the value of the 0.2% proof stress relative to the tensile strength value at 25° C. may be referred to as a YP value. If the YP value is no less than 70%, the aluminum alloy material of the embodiment has high 0.2% proof stress at room temperature. If the YP value is no less than 75% and no less than 80%, the aluminum alloy material of the embodiment is superior in proof stress at room temperature and is preferable.

The value of 0.2% proof stress is usually smaller than the value of tensile strength. Thus, the above-mentioned YP value is less than 100%.

<<Elongation After Fracture>>

One example of the aluminum alloy material of the embodiment includes that the material has an elongation after fracture of no less than 3% at 25° C. When Fe is precipitated as mentioned above, the parent phase easily exhibits ductile behavior. As mentioned above, the fine compound particles do not easily become a starting point of cracking. Therefore, the aluminum alloy material of the embodiment has excellent strength and proof stress at room temperature, while having excellent elongation.

If the elongation after fracture at 25° C. is no less than 3%, the toughness is high at room temperature. Such aluminum alloy material is easily bent or the like. If the elongation after fracture is no less than 3.5%, no less than 4.0%, and no less than 4.5%, the aluminum alloy material of the embodiment is superior in toughness at room temperature.

The aluminum alloy material of the embodiment in which elongation after fracture at 25° C. is, for example, no less than 3% and no more than 25%, and no less than 3.5% and no more than 20% easily has high tensile strength, high 0.2% proof stress, and high elongation after fracture in good balance at room temperature.

<<Heat Resistance>>

In the aluminum alloy material of the embodiment, the tensile strength does not easily decrease at high temperature, for example 250° C., as mentioned above. Quantitatively, the rate of reduction in tensile strength determined from the tensile strength value at 25° C. and the tensile strength value at 250° C. includes no more than 0.30%/° C. The rate of reduction in tensile strength (%/° C.) is a value determined from the following equation.

The rate of reduction in tensile strength=[(Tᵣ−Tₕ)/{(250−25)×Tᵣ}]×100

Tᵣ is the value of tensile strength (MPa) at 25° C. Tₕ is the value of tensile strength (MPa) at 250° C.

If the rate of reduction in tensile strength is no more than 0.30%/° C., the amount of reduction in tensile strength at 250° C. is small. Therefore, high tensile strength is ensured at 250° C. From this point, the aluminum alloy material of the embodiment is excellent in heat resistance. If the rate of reduction in tensile strength is no more than 0.28%/° C., no more than 0.25%/° C., and no more than 0.20%/° C., the amount of reduction in tensile strength is smaller. Such the aluminum alloy material of the embodiment is superior in heat resistance.

An ideal value of the rate of reduction in tensile strength is 0%/° C. When the rate of reduction in tensile strength is closer to 0%/° C., the aluminum alloy material of the embodiment is excellent in heat resistance and is preferable.

<Electrical Property>

One example of the aluminum alloy of the embodiment includes that the material has a conductivity of no less than 25% IACS at 25° C. When Fe is precipitated as mentioned above, the reduction in conductivity properties caused by the solid solution of Fe is inhibited. As mentioned above, the fine compound particles do not easily interfere with the conductive path of Al. Therefore, the aluminum alloy material of the embodiment has excellent strength and proof stress at room temperature, while having excellent conductive properties.

If the conductivity at 25° C. is no less than 25% IACS, the conductivity is high at room temperature. Such the aluminum alloy material of the embodiment can be suitably used as conductive members such as spring contacts. If the conductivity is no less than 28% IACS, the aluminum alloy material of the embodiment is superior in conductive properties at room temperature.

The aluminum alloy material of the embodiment allows additive elements to form a solid solution in Al. Therefore, examples of the conductivity of the aluminum alloy material of the embodiment includes no less than 25% IACS and no more than 50% IACS.

<Method for Adjusting Properties>

The average grain size of the above-mentioned crystal grains, the average length of the compound particles, tensile strength of the aluminum alloy material, 0.2% proof stress, elongation after fracture, and conductivity can be modified, for example, by adjusting the content of the additive elements, relative density, and production conditions. For example, the larger the content of the additive elements in the above-mentioned range, the higher the tensile strength and 0.2% proof stress tend to be. For example, the smaller the content of Fe in the above-mentioned range, the smaller the above-mentioned average grain size and average length tend to be. In addition, the smaller the content of the additive elements in the above-mentioned range, the higher the elongation after fracture tends to be.

### Example of Use

The aluminum alloy material of the embodiments can take various shapes and sizes. Examples of the aluminum alloy material of the embodiment include solid bodies represented by bars, wire rods, or plates, and cylindrical bodies having through holes. Since the aluminum alloy material of the embodiment has excellent mechanical properties at room temperature as mentioned above, it can be used as a product for use at room temperature. Since the aluminum alloy material of the embodiment also has excellent heat resistance as mentioned above, it can be used as a product that may be used in a high temperature environment, for example, 200° C. to 250° C. Note that the shape and size in the aluminum alloy material of the embodiment can be modified by adjusting the shape of the forming die, the work amount of cutting working, plastic working, or the like.

Alternatively, the aluminum alloy material of the embodiment has a fine structure and excellent elongation as mentioned above, resulting in excellent plastic workability. Therefore, the aluminum alloy material of the embodiment can be used as a base material provided for plastic working such as forging, extrusion, drawing, and rolling. The plastic working may be cold working. When the aluminum alloy material of the embodiment is used as a base material for the plastic working, the high degree of freedom in shape makes it possible to produce aluminum alloy products of various shapes. From this point, the aluminum alloy material of the embodiment contributes to the mass production of a variety of aluminum alloy products.

(Main Effect)

The aluminum alloy material of the embodiment has excellent strength and proof stress at room temperature. The aluminum alloy material of the embodiment is also excellent in heat resistance. Furthermore, the aluminum alloy material of the embodiment has also excellent in elongation and conductive properties at room temperature. These effects will be specifically described later in Test Example 1.

[Method of Producing Aluminum Alloy Material]

(Summary)

The aluminum alloy material of the embodiment is produced, for example, by a production method comprising the following steps.

(First Step) The molten metal consisting of an aluminum alloy that contains no less than 1.2 at % and no more than 6.5 at % of Fe, no less than 0.15 at % and no more than 5 at % of at least one first element selected from the group consisting of Nd, W, and Sc, no less than 0.005 at % and no more than 2 at % of at least one second element selected from the group consisting of C and B, and the balance being Al and inevitable impurities is quenched to produce a solidified material in which Fe forms a solid solution.
(Second Step) The solidified material is used to prepare an intermediate material with a relative density of no less than 80%, at either cold or warm temperature.
(Third Step) The intermediate material is used to prepare a formed product of a predetermined shape at a temperature at which the above compound precipitates.
(Fourth Step) The formed product is subjected to heat treatment.

The solidified material produced by quenching the molten metal is a solidified matter in which Fe substantially form a solid solution in Al and thus compounds including Al and Fe is not substantially precipitated. Alternatively, the solidified material is a solidified matter in which even if the compounds are precipitated, the compounds are very fine particles such as less than 10 nm and are not coarse. The crystal grains are also fine by quenching. Such a solidified material has excellent plastic workability in that there is substantially no effect of the compound, which becomes a starting point of fracture during working. Therefore, the solidified material can form homogeneously the intermediate material whose relative density is as large as mentioned above. In other words, it is possible to produce dense intermediate materials. Although the compounds are precipitated when the intermediate material is formed, they can easily become fine particles, especially by the effect of the second element. The fineness of the compounds makes it easier for the crystal grains to be maintained in a fine state.

The compounds are then easily controlled to an appropriate size by performing heat treatment independently from working to the formed product. As a result, an aluminum alloy material of the embodiment in which fine particles consisting of the compounds are dispersed in the fine crystal structure can be produced. In addition, the heat treatment removes the strains caused during forming. Therefore, the aluminum alloy material of the embodiment with excellent elongation and electrical conductivity is produced. The production method can produce the aluminum alloy material of the embodiment with high productivity using a solidified material with excellent plastic workability as mentioned above.

Moreover, when Fe, the main additive element, satisfies the above-mentioned condition (I), steps such as heat treatment can be carried out in a temperature range where the above compounds can be maintained in a fine state. When Fe satisfies the above-mentioned condition (II), the dissolution and casting steps can be carried out at a relatively low cost. In view of these factors, the above production method can produce the aluminum alloy material of the embodiment with high productivity.

The following describes each step.

(First Step)

<Summary>

In this step, a solidified material in which Fe substantially forms a solid solution in Al is typically produced by quenching molten metal consisting of an aluminum alloy having the above-mentioned specific composition. In the solidified material, compounds including Al and Fe, such as Al₁₃Fe₄-type compounds and Al₆Fe-type compounds are not substantially precipitated. The solidification rate of molten metal here, as described in PTL 1, is preferably no less than 1×10⁵° C./sec (100,000° C./sec).

<Raw Material>

The raw material for the solidified material includes a parent alloy having the above-mentioned specific composition. Examples of the raw materials for the parent alloy include pure aluminum powder, pure iron powder, the following Al-based alloy powders, Fe-containing alloy powder, and diamond powder. If necessary, the parent alloy can be subjected to solution treatment.

Examples of Al-based alloys include alloys that include Al and one first element, with the balance being Al and inevitable impurities.

The content of the first element in the Al-based alloy may satisfy, for example, a composition ratio of an eutectic alloy with a melting point of no more than 1,000° C., a composition ratio close to the above composition ratio, or a composition ratio with less content of the first element than the above composition ratio of the eutectic alloy.

Examples of Fe-containing alloys include alloys that include Fe and at least one element of one first element and one second element, with the balance being Al and inevitable impurities. Specific examples of Fe-containing alloys include alloys including Nd and Fe, alloys including Nd, C, and Fe, and alloys including Nd, B, and Fe, and alloys including C and Fe.

Examples of the content of Nd in an alloy including Nd and Fe include no less than 20 at % and no more than 25 at %. The alloy including Nd and Fe may also be an eutectic alloy. The lower the melting point of the Fe-containing alloy, the more preferable it is in terms of manufacturability, and the like.

Examples of the content of Nd in an alloy including Nd, Fe, and C include no less than 10 at % and no more than 15 at %; and the content of C include no less than 0.5 at % and no more than 1.5 at %. One example of an alloy containing Nd, Fe, and C includes NdFe₄C₄.

Examples of the content of C in an alloy including C and Fe include no less than 15 at % and no more than 20 at %.

An Al-based alloy powder and an Fe-containing alloy powder may include a high concentration of the first and second elements. When using the Al-based alloy powder and the Fe-containing alloy powder, the amount of pure aluminum powder or the like added is adjusted so that the content of Fe, the content of the first element, and the content of the second element in the parent alloy are in a predetermined range.

Moreover, examples of the average grain size of a diamond powder include no more than 1 μm.

<Shape of Solidified Material>

The solidified material is either in a ribbon shape or in powder. In the case of ribbon, the thickness is thin, and in the case of a powder, the powder diameter is small, thereby making it easy to achieve a solidification rate of no less than 1×10⁵° C./sec. The ribbon-like solidified material is grinded into a powder. Alternatively, the ribbon-like solidified material is crushed into short flakes so that it has a length equal to the thickness of the ribbon, for example. If the solidified material is in powder or flakes, it is excellent in plastic workability. Therefore, a dense intermediate material is easily formed.

<Size of Solidified Material>

Examples of the thickness of the above-mentioned ribbon or flake include no less than 1 μm and no more than 100 μm, and even no more than 50 μm, no more than 40 μm. Examples of the diameter of the powder includes no less than 5 μm and no more than 200 μm, and even no more than 100 μm, and no more than 20 μm.

<Method of Producing Solidified Material>

A method of producing the ribbon-like solidified material includes a so-called liquid quenching solidification method. One example of the liquid quenching solidification method includes the meltspan method.

A method of producing the powdery solidified material includes an atomization method. One example of the atomization method includes the gas atomization method.

The meltspan method is a method of preparing a ribbon by injecting a molten metal of the raw material onto a cooling medium such as a roll or disc rotating at high speed and quenching. The constitutional materials of the cooling medium include metals such as copper. In the meltspan method, although it depends on the content of the additive elements in the molten metal, the thickness of the ribbon, and the like, the above-mentioned solidification rate can be no less than 1.2×105° C./sec. The solidification rate may be no less than 1.5×10⁵° C./sec, no less than 5.0×10⁵° C./sec, and no less than 1.0×10⁶° C./sec. The rotation rate is adjusted so that the solidification rate is no less than 1×10° C./sec.

The atomization method is a method of preparing powders by pouring the molten metal of the raw material out through small holes at the bottom of the crucible and quenching it by spraying a thin stream of the molten metal with a high-pressure jet of gas or water having high cooling capacity. The gas includes argon gas, air, and nitrogen. In the atomization method, the production conditions are adjusted so that the above-mentioned solidification rate is no less than 1×10° C./sec. The conditions to be adjusted include the gas type, molten metal injection pressure, molten metal flow rate, molten metal spatial density, and molten metal temperature. The spatial density of the molten metal is a relative density to the true density of the aluminum alloy when the molten metal is assumed to be a mixture of the aluminum alloy and the injection gas. This relative density is determined by considering the volume of the molten metal as the volume of the mixture.

The present inventors have also obtained the following findings.

(1) In a solidified material in which Fe is not substantially precipitated as mentioned above, fracture starting from precipitates does not easily occur. Such a solidified material can be subjected to homogeneous plastic working by applying appropriate pressure and temperature. Therefore, rolling, such as powder rolling, can be better performed.
(2) The rolled material that has been subjected to the above rolling has excellent plastic workability to the extent that it can form a dense intermediate material even in cold working.

From the above findings, the powdery solidified material may be a solidified material produced by quenching the above-mentioned molten metal, and then further rolled and grinded.

<<Measurement of Solidification Rate>>

The above-mentioned solidification rate may be adjusted based on the composition of the molten metal, the temperature of the molten metal, and the size such as the powder diameter and thickness, and the like of the solidified material to be produced. The measurement of the solidification rate is determined, for example, by observing the temperature of the molten metal in contact with a form using a highly sensitive infrared thermography camera. Examples of the infrared thermography camera include A6750 manufactured by Teledyne FLIR LLC. The time resolution is 0.0002 seconds. Examples of the form include a copper roll in the meltspan method described later. The solidification rate (° C./second) is determined by (hot water temperature−300)/t. t (sec) is the time elapsed between cooling from the hot water temperature (° C.) to 300° C. For example, if the hot water temperature is 700° C., the solidification rate is determined by 400/t (° C./sec).

<Structure of Solidified Material>

The larger the above solidification rate is, the more easily the solidified material can be obtained that includes almost no compound including Al and Fe, especially coarse compound particles of no less than 1,000 nm, and it is preferable. Here, in the structural analysis by X-ray diffraction (XRD), the ratio of the top peak intensity of Al to the top peak intensity of the above compound (top peak intensity of Al/top peak intensity of the above compound) is theoretically equivalent to the volume ratio when the total amount of Fe is assumed to be precipitated. In the above theoretical ratio, the difference between the denominator and the numerator is not so large. In contrast, in the above-mentioned solidified material, the denominator, “top peak intensity of the above compound,” is very small compared to the numerator, “top peak intensity of Al.” Therefore, in the solidified material, the above ratio is large. Examples of the ratio include no less than 10 times, no less than 12 times, no less than 15 times, and no less than 20 times the theoretical ratio. The larger the ratio, the higher the proportion of the amount of solid solution to the total amount of Fe and the lower the proportion of Fe present as the above compound. Solidified materials with a high proportion of the amount of the solid solution do not easily include coarse compound particles. Therefore, the coarse compound particles do not become a starting point of cracking. From this point, the solidified material with a high proportion of solid solution is superior in plastic workability. Note that the ratio does not substantially change even if the solidified material is subjected to above-mentioned powder rolling or the like.

(Second Step)

In this step, the above-mentioned powdery solidified material or thin flakes of solidified material are formed to produce a dense intermediate material. This forming is performed at a temperature where the compound including Al and Fe does not precipitate, i.e., at a cold or warm temperature. The densification reduces the internal voids. Therefore, cracking caused by stress concentration in the voids does not easily occur. In addition, the structure of the intermediate material typically maintains the structure of the solidified material substantially, or has a structure close to it.

Therefore, the intermediate material is substantially free of coarse compound particles and coarse crystal grains. From this point, the intermediate material is excellent in plastic workability. Even when warm working is performed, the amount of precipitation of compound particles is small, and the compound particles are also very fine.

<Cold Working>

In cold working, the above-mentioned compounds are not substantially precipitated, and crystal grains are not substantially grown during forming. Therefore, an intermediate material that is substantially free of the compounds and has a fine crystal structure is easily produced. Examples of cold working include press forming using a uniaxial pressing apparatus or the like.

Examples of processing temperatures in cold working include approximately ambient temperature. The ambient temperature is a temperature in the range of 5° C. to 35° C., and includes room temperature of approximately 25° C. At ambient temperature, the precipitation of the above-mentioned compounds and the growth of crystals are inhibited. In addition, no thermal energy is required in this forming process. From this point, the production cost is reduced.

The working temperature in cold working may be exceeding ambient temperature and less than 250° C. In this case, the plastic workability of the solidified material is improved. Therefore, the intermediate material is easily formed. The working temperature may be no more than 240° C., no more than 200° C., and no more than 150° C.

The applied pressure in cold working may be selected in a range where the intermediate material after forming has a relative density of no less than 80%. Examples of the applied pressure include no less than 0.1 GPa and no more than 2.0 GPa. The applied pressure may be no less than 0.5 GPa, no less than 0.8 GPa, and no less than 1.0 GPa. Although it depends on the composition and size of the above-mentioned solidified material or the like, the higher applied pressure easily results in a higher relative density of the intermediate material. Therefore, a dense intermediate material is easily obtained.

<Warm Working>

Compared to cold working, warm working can enhance the plastic workability of the above-mentioned solidified material. Therefore, the intermediate material can be better formed. Examples of warm working include press forming using a uniaxial pressing apparatus or the like, so-called hot pressing. Alternatively, examples of warm working include warm extrusion.

Examples of the working temperature in warm working include no less than 300° C. and less than 400° C. If the working temperature is no less than 300° C., the plastic workability of the above-mentioned solidified material is improved. If the working temperature is less than 400° C., the precipitation of the above-mentioned compound easily decreases. In addition, the above compounds do not easily become coarse. The crystal grains of the parent phase do not easily become coarse. As a result, the solidified material is excellent in plastic workability. From the viewpoint of good plastic workability and inhibition of the growth of the compounds and crystals or the like, the working temperature may be no less than 320° C. and no more than 390° C., and no more than 380° C. If the working temperature is no more than 375° C. and no more than 350° C., the compounds do not substantially precipitate, making it easier to perform forming.

The working temperature in warm working is a temperature at which the solidified material is heated, that is, a preheating temperature. Examples of the heating time include no less than 1 minute and no more than 30 minutes. The atmosphere during heating includes air atmosphere, nitrogen atmosphere, vacuum atmosphere, and the like. If the atmosphere is air atmosphere, there is no need to control the atmosphere. From this point, warm working is easily performed.

The applied pressure in warm working may be selected in a range where the intermediate material after forming has a relative density of no less than 80%. Examples of the applied pressure include no less than 50 MPa and no more than 2.0 GPa. The applied pressure may be no less than 100 MPa (0.1 GPa) and no less than 700 MPa. If the applied pressure is no less than 1.0 GPa and no less than 1.5 GPa, the intermediate material easily become dense.

<Relative Density>

If the intermediate material has a relative density of no less than 80%, hot working and the like are easily performed in the next step. Also, the formed product produced in the next step has easily a relative density of no less than 80%. As a result, a dense aluminum alloy material is produced. From the viewpoint of good plastic workability, densification, and the like, the intermediate material preferably has a relative density of no less than 85%, and even no less than 90%, no less than 92%, no less than 93%, and no less than 95%. If the warm working is warm extrusion, an intermediate material with a higher relative density is produced. Although it depend on the conditions of the solidified material before extrusion, extrusion conditions, or the like, examples of the relative density of the extruded product, which is the intermediate material, include no less than 98%, and even no less than 99%, and substantially 100%.

<Other Forming Method>

In addition to the above-mentioned hot pressing and extrusion, the above-mentioned powdery solidified material can be stored in a metal tube and extruded, with both ends of the metal tube sealed. Examples of the metal tube include those composed of pure aluminum or aluminum alloy, pure copper or copper alloy, and the like. After extrusion, a surface layer based on the metal tube may be removed or may be left behind. If the surface layer is left behind, a coated aluminum alloy material is produced with the surface layer as the coating layer.

(Third Step)

In this step, the above-mentioned intermediate materials are further formed to produce a formed product in predetermined shape. This forming is performed at a temperature at which a compound including Al and Fe can be precipitated, for example, hot. Hot working can further improve the plastic workability of the intermediate material. Therefore, a formed product of a predetermined shape can be better formed.

Examples of the working temperature in hot working include no less than 400° C. and no more than 500° C. If the working temperature is no less than 400° C. the plastic workability of the intermediate material is improved. Therefore, a formed product of a predetermined shape can be better formed. If the heating temperature is no more than 500° C., compounds including Al and Fe are precipitated, but the compounds do not easily become coarse. The crystal grains of the parent phase do not easily become coarse. As a result, the intermediate material is excellent in plastic workability. From the viewpoint of good plastic workability and inhibition of the growth of the compounds and crystals or the like, the working temperature may be no less than 400° C. and no more than 480° C., and no less than 400° C. and no more than 450° C.

The working temperature in hot working is the temperature at which the intermediate material is heated, that is, the preheating temperature. Examples of the heating time include no less than 1 minutes and no more than 30 minutes. In the atmosphere during heating, the atmosphere described in the conditions of the above-mentioned warm working can be used.

Examples of the hot working include hot extrusion and hot forging.

(Heat Treatment Step)

In this step, the above-mentioned formed product is subjected to heat treatment to precipitate compounds including Al and Fe, or to adjust the size of the compounds that have already been precipitated, thereby producing an aluminum alloy material having a structure in which the above compounds are dispersed. Such an aluminum alloy material is excellent in strength and proof stress as mentioned above. For example, the heat treatment conditions may be adjusted so that the aluminum alloy material after heat treatment has a tensile strength of no less than 275 MPa at 25° C. Alternatively, the heat treatment conditions may be adjusted so that the above-mentioned YP value in the aluminum alloy material after heat treatment satisfies no less than 70%. The heat-treated aluminum alloy material is also excellent in elongation and conductivity by the reduction of strain as mentioned above. Therefore, the heat treatment conditions may be adjusted so that the aluminum alloy material after heat treatment not only has a tensile strength of no less than 275 MPa at 25° C. but also satisfies at least one of conditions: having an elongation after fracture of no less than 5% and having a conductivity of no less than 25% IACS.

The heat treatment may be batch treatment or continuous treatment. The batch treatment is a treatment in which the heat-treated object is sealed in a heating vessel, such as an atmosphere furnace, and is heated. The continuous treatment is a treatment in which the heat-treated object is continuously supplied to a heating vessel, such as a belt furnace, and is heated.

<Batch Treatment>

In batch treatment, examples of the heating temperature include exceeding 300° C. and no more than 550° C. If the heating temperature is exceeding 300° C., the size of the compounds including Al and Fe is adjusted, and strains caused by the above-mentioned hot working is removed. If the heating temperature is no more than 550° C., the compounds do no easily become coarse. The crystals constituting the parent phase also do not easily become coarse. In addition, thermal transformation of the compound is easily prevented. The heating temperature may be no less than 400° C. and no more than 550° C., and even no less than 450° C.

Examples of the holding time include no less than 10 seconds and no more than 6 hours. The higher the heating temperature, the more easily the compound including Al and Fe is precipitated even if the holding time is short. The shorter the holding time, the more enhanced the productivity of the aluminum alloy material in terms of the shorter production time. Although it depends on the content of the additive elements, the size of the formed product, or the like, the holding time may be no less than 0.1 hours and no more than hours 4 hours, and even no less than 1 hour and no more than 3 hours, no more than 2 hours, and no more than 1.5 hours. After the predetermined holding time has elapsed, the heating is stopped and the heat treatment by batch treatment is completed.

<Continuous Treatment>

In continuous treatment, for example, the parameters are adjusted so that the tensile strength, 0.2% proof stress, elongation after fracture, conductivity, or the like of the aluminum alloy material after heat treatment satisfy the above-mentioned range. The parameters include current value, transfer speed, furnace size, and the like.

<Atmosphere>

Examples of atmospheres during heat treatment include an air atmosphere or a low-oxygen atmosphere. For an air atmosphere, there is no need to control the atmosphere. A low-oxygen atmosphere is an atmosphere in which the oxygen content is lower than that of the air. From this point, the surface oxidation of the aluminum alloy material is reduced. The low-oxygen atmosphere includes vacuum atmosphere, inert gas atmosphere, and reducing gas atmosphere, and the like.

(Other Step)

The intermediate material produced in the second step, the formed product produced in the third step, and the heat-treated material produced in the fourth step may be subjected to cutting or other working, if necessary.

### Test Example 1

The structure and properties of aluminum alloy materials of various compositions are shown below.

(Table Description)

The following Table 1 and Table 2 show the composition and structure of each aluminum alloy material. Table 3 and Table 4 show the properties of each aluminum alloy material.

Table 1 and Table 3 show samples formed of aluminum alloys containing Fe, one of the elements Nd, W, or Sc, and C.

Table 2 and Table 4 show samples formed of aluminum alloy containing Fe, one of the elements Nd, W, or Sc, and B.

Hereinafter, Nd, W and Sc may be referred to as the first element, and C and B may be referred to as the second element.

(Preparation of Sample)

The aluminum alloy material of each sample is prepared as follows.

<Preparation of Solidified Material>

A molten aluminum alloy including Fe, the first element, and second element with the balance being Al and inevitable impurities is prepared. The molten metal here is prepared using a parent alloy. The parent alloy may be prepared using pure aluminum powder, pure iron powder, Al-based alloy powder, Fe-based alloy powder, diamond powder, or the like as a raw material. The content of the first and second elements (at %) shown in Table 1 and Table 2 is an atom proportion when taking the aluminum alloy as 100 at %. The amount of the raw material added is adjusted so that the contents of Fe, the first element, and the second element are the contents shown in Table 1 and Table 2.

A ribbon is prepared using the above-mentioned molten metal by the meltspan method under the following conditions. The resulting ribbon is grinded to a powder form.

The molten metal is prepared by melting the above-mentioned parent alloy at temperature raised to 1,000° C. in argon atmosphere under reduced pressure (−0.02 MPa). A ribbon is prepared by injecting the molten metal into a copper roll rotating at a peripheral rate of 50 m/s. The solidification speed here is 7.5×10⁶° C./sec. The ribbon has a width of approximately 2 mm. The ribbon has a thickness of approximately 30 μm. The length of the ribbon is undefined.

When performing structural analysis of the resulting ribbon of each sample by XRD, compounds including Al and Fe, for example, the peak of Al₁₃Fe₄ can be seen. However, the ratio (top peak intensity of Al/top peak intensity of the above compound) is more than 10 times the above-mentioned theoretical ratio. In addition, when the cross-section of the ribbon of each sample was observed by scanning electron microscopy (SEM), no compound with a size of no less than 1,000 nm is seen. The magnification of the observation here is 10,000×. From these facts, the ribbon of each sample is substantially free of coarse compound particles.

<Preparation of Intermediate Material>

The intermediate material is prepared using powder obtained by grinding the above-mentioned ribbon. Here, the powder is dried to remove the water adsorbed on the surface of the powder, and then cold-worked to prepare a first formed product with a relative density of no less than 50%. Next, the first formed product is preheated and warm-worked to prepare a second formed product with a relative density of no less than 80%. The second formed product is an intermediate material. The intermediate material is a cylinder with a diameter of 40 mm and a length of 50 mm.

The forming of the first formed product is a cold press forming. The cold press forming here is done at room temperature. The applied pressure is 0.1 GPa.

The forming for the second formed product is a warm press forming that involves the following preheating. The applied pressure is 1 GPa. The preheating is performed using a forming jig that has been preheated to 400° C. The preheating conditions are an air atmosphere and a holding time of 30 minutes. The temperature of the first formed product heated by the forming jig is 350° C.

<Preparation of Extruded Material>

The above-mentioned intermediate material is subjected to hot working to prepare a formed product. The hot working is a hot extrusion that involves the following preheating. The preheating is performed using a forming jig that has been preheated to 500° C. The preheating conditions are an air atmosphere and a holding time of 10 minutes. The temperature of the intermediate material heated by the forming jig is a temperature selected from the range of 400° C. to 450° C. The extrusion pressure is a maximum of 1 GPa. The extrusion pressure is adjusted so that the extruded material has a relative density of 98% to 1001%. This extruded material by the hot extrusion is the formed product. The prepared formed product is a cylinder with a diameter of 10 mm and a length of about 700 mm. Note that a heat-treated material in which the formed product has been subjected to the following heat treatment will substantially maintain the relative density of the extruded material. The relative density of the extruded material depends on the quality of the intermediate material, and even if the extrusion pressure is adjusted to 1 GPa, the above-mentioned maximum pressure, and the extruded material may have a relative density of less than 98%. As a result, the heat-treated material may also have a relative density of less than 98%.

<Heat Treatment>

The above-mentioned extruded material is subjected to heat treatment to prepare the aluminum alloy material of each sample. The conditions of the heat treatment are a heating temperature of 450° C. and a holding time of 30 minutes.

(Structure Observation)

For the aluminum alloy material of each sample, any cross section is taken and observed by SEM. In all samples, the parent phase has a crystal structure. In all samples, a compound including Al and Fe is present in the parent phase. The compound are mainly a precipitate. The particles composed of the above compound are dispersed in the parent phase. Here, the “compound including Al and Fe” means a compound in which an atomic proportion of Fe to Al is no less than 0.1 (no less than 10 at %). One example of this compound includes Al₁₃Fe₄.

In the cross section, the average grain size (nm) of the crystal grains forming the parent phase, the average length (nm) of the compound particles, and the aspect ratio of the compound particles are shown in Table 1 and Table 2.

The average grain size of the crystal grains of the parent phase (nm) is determined as follows.

The cross section of the aluminum alloy material is observed by SEM. From the SEM image of this cross section, a 10 μm×10 μm measurement area is taken as a field of view. A total of no less than 30 measurement areas is taken from one cross section or a plurality of cross sections. All the crystal grains present in each measurement area are extracted. A circle having an area equivalent to the cross-sectional area of each crystal grain is determined. The diameter of this circle, i.e., the diameter of the equivalent area circle, is used as the grain size of the crystal grain. The grain size of the extracted crystal grains is averaged. The average value determined is the average grain size.

Note that crystal grains having a grain size of no less than 50 nm are extracted here. In other words, crystal grains with a grain size of less than 50 nm are not used in the calculation of the average grain size. The magnification of the observation is 10,000×. The resolution at this magnification is not sufficient to clearly measure crystals of less than 10 nm and compound particles of less than 10 nm, which will be described later. Therefore, crystals of no less than 50 nm are used here to calculate the average grain size.

The extraction of the crystal grains and of the compound particles described later can be easily performed by image processing of the SEM image using commercially available image processing software. Note that a metallurgical microscope can also be used to observe the cross section. The magnification of the microscope is adjusted to the extent that the size of the object to be measured can be clearly measured, as mentioned above or as described later. In observing the cross section, it is effective to perform grain boundary etching with appropriate solution treatment. In observing the cross section, it is also effective to create an SEM image having information on crystal orientation by EBSD (Electron Backscatter Diffraction).

The average length of the compound particles (nm) is determined as follows.

The cross section of the aluminum alloy material is observed by SEM. From the SEM image of this cross section, a measurement area of 10 μm×10 μm is taken. A total of no less than 30 measurement areas is taken from one cross section or a plurality of cross sections. All the compound particles precipitated in each measurement area are extracted. The maximum length of each compound particle is measured. The maximum length is measured as follows. As shown in FIG. 2, in the SEM image of the above-mentioned cross section, the compound particle 1 is sandwiched by two parallel lines P1 and P2. In this state, the spacing between the parallel lines P1 and P2 is measured. The spacing is the distance in the direction perpendicular to the parallel lines P1 and P2. Several pairs of parallel lines P1 and P2 in any direction are taken and the above spacing is each measured. For example, no less than 5 pairs of parallel lines P1 and P2 are taken. The maximum value of the plurality of the spacing measured is the maximum length L1 of the compound particle 1. The maximum lengths of the extracted compound particles are averaged. The average value determined is the average length. Here, the magnification of the observation is 10,000×. Here, compound particles with a maximum length of no less than 10 nm, which can be clearly distinguished, are extracted as mentioned above. In other words, compound particles with a maximum length of less than 10 nm are not used in the calculation of the average length.

The aspect ratio of a compound particle is a ratio of the major axis length to the minor axis length of the compound particle, i.e., (major axis length/minor axis length).

The major axis length (nm) is the maximum length of the above-mentioned compound particles. The minor axis length (nm) is the maximum value among the lengths of the line segments taken in the direction perpendicular to the major axis direction. Here, the aspect ratio is determined for compound particles with a maximum length of no less than 10 nm, as mentioned above. The aspect ratios of these compound particles are averaged. The average value determined is the aspect ratio.

(Component Analysis)

Moreover, the Al ratio (at %) in the parent phase is shown in Table 1 and Table 2. The determination of the Al ratio includes determination by identifying the elements constituting the parent phase and measuring the Al content (at %) in the parent phase. The identification, an apparatus capable of local component analysis such as a transmission electron microscope (TEM) equipped with a measuring apparatus using energy dispersive X-ray spectroscopy (EDX) is used.

Note that the structure of the above-mentioned compound can be examined by structural analysis using XRD in the cross section of the aluminum alloy material. For example, it can be examined that the compound is Al₁₃Fe₄. This analysis is greatly affected by surface oxides and other factors. Therefore, the analysis can be performed with high accuracy if the surface oxides and other factors are sufficiently removed. The analysis can be performed with high accuracy if the interior of the sample is evaluated by transmission XRD using radiation or the like. In addition, the identification of the elements constituting the compound can be used to confirm that the compound including Fe and Al includes Nd, for example.

(Relative Density)

The relative density of the aluminum alloy material of each sample is shown in Table 3 and Table 4.

The relative density of the aluminum alloy material is determined by (apparent density/true density)×100 and rounded to a value after the decimal point. The true density of aluminum alloy material is determined, for example, as follows.

For the aluminum alloy material of each sample, component analysis, X-ray diffraction analysis, and structure observation are performed. From these analyses and observations, the crystal structure and volume ratio are determined for the substances constituting the aluminum alloy material of each sample.

The crystal structure of the above-mentioned constituent materials is defined by the length of the three sides in the Bravais lattice (a, b, c) and the solid angles of the three sides (α, β, γ). The variables that define the Bravais lattice (a, b, c, α, β, γ) can be determined by determining the following lattice plane spacing. The lattice plane spacing is determined by the Bragg equation using the diffraction angles of the X-ray diffraction peaks for no less than 6 non-parallel plane orientations in the Bravais lattice corresponding to the above-mentioned constituent substances. The resulting variables (a, b, c, α, β, γ) that define the Bravais lattice are used to calculate the atomic mass and volume of the Bravais lattice. The ratio of the atomic mass to the volume is taken as the Bravais lattice density.

The volume ratios of the above-mentioned constituent substances are determined from structure observations. A cross section of the sample is taken in any of the three perpendicular axes. In other words, three cross sections are taken: one in the x-axis direction, one in the y-axis direction, and one in the z-axis direction. For each of the three cross sections, no less than 30 SEM images are taken. The imaging field of view, i.e., measurement area, is set to be 10 μm×10 μm. The number of images taken for each of the three cross sections is the same. The SEM magnification is 10,000×. The total area of the constituent substances in each SEM image is determined. The ratio of the total area of the constituent substances in each imaging field of view is determined by taking the area of each imaging field of view as 100%. This ratio takes a value of no less than 0% and no more than 100%. The average of the ratios of areas in all imaging field of view is considered as the volume ratio. The averaging of the ratio of the areas in the cross sections in the above-mentioned three axial directions allows the volume ratio to be determined more appropriately than when the ratio of the areas in the cross section in any one direction is considered as the volume ratio.

The true density of an aluminum alloy material is the value obtained by additive averaging the Bravais lattice densities of the respective constituent substances using the volume ratios of the constituent substances.

(Property)

<Mechanical Property and Electrical Property>

The tensile strength (MPa), 0.2% proof stress (MPa), elongation after fracture (%), and conductivity (% IACS) for each sample of aluminum alloy material are shown in Table 3 and Table 4.

The tensile strength (MPa) and elongation after fracture (%) are measure in accordance with JIS Z 2241:1998, “Metal Material Tensile Test Method.” Here, tensile strength and elongation after fracture at 25° C. and tensile strength at 250° C. are each measured. The measurement includes the use of a commercially available measuring apparatus that can perform tensile tests at 25° C. and 250° C.

The 0.2% proof stress is calculated from the stress-strain curve, i.e., SS curve in the tensile tests.

The value of 0.2% proof stress to the value of the tensile strength, i.e., YP value, is also shown in Table 3 and Table 4. The YP value is obtained by “value of 0.2% proof stress/value of tensile strength.”

<Heat Resistance>

The rate of reduction in strength (%/° C.) for each sample of aluminum alloy material is shown in Table 3 and Table 4. Here, the rate of reduction in strength is a rate of reduction in tensile strength determined from the value of tensile strength at 25° C. and the value of tensile strength at 250° C.

The rate of reduction in tensile strength is determined by [(Tᵣ−Tₕ)/{(250−25)×Tᵣ}]×100. Tᵣ is the tensile strength value at 25° C. Tₕ is the tensile strength value at 250° C.

TABLE 1

| | | | | | | Structure of extruded material | | | |
|---|---|---|---|---|---|---|---|---|---|
| | | | | | | Parent phase | | | |
| | Composition | | | | | | Average | Particle composed of | |
| | Fe | First element | | Second element | | | crystal grain | compound including Al and Fe | |
| Sample | Content | | Content | | Content | Al ratio | size | Average length | Aspect |
| No. | (at %) | | (at %) | | (at %) | (at %) | (nm) | (nm) | ratio |
| 1 | 1.0 | Nd | 0.20 | C | 0.05 | >99 | 1410 | 70 | 2.1 |
| 2 | 1.2 | Nd | 0.20 | C | 0.05 | >99 | 1440 | 103 | 2.4 |
| 3 | 1.5 | Nd | 0.20 | C | 0.05 | >99 | 1500 | 116 | 2.5 |
| 4 | 5.0 | Nd | 0.20 | C | 0.05 | >99 | 1590 | 128 | 2.7 |
| 5 | 6.5 | Nd | 0.20 | C | 0.05 | >99 | 1620 | 137 | 3.4 |
| 6 | 8.0 | Nd | 0.20 | C | 0.05 | >99 | 1740 | 163 | 3.9 |
| 7 | 5.0 | Nd | 0.10 | C | 0.05 | >99 | 1830 | 335 | 3.6 |
| 8 | 5.0 | Nd | 0.15 | C | 0.05 | >99 | 1660 | 135 | 2.9 |
| 9 | 5.0 | Nd | 5.00 | C | 0.05 | >99 | 1400 | 43 | 2.1 |
| 10 | 5.0 | Nd | 7.50 | C | 0.05 | 98 | 1160 | 31 | 1.9 |
| 11 | 5.0 | Nd | 0.20 | C | 0.0025 | >99 | 2200 | 175 | 3.3 |
| 12 | 5.0 | Nd | 0.20 | C | 0.005 | >99 | 1670 | 130 | 2.7 |
| 13 | 5.0 | Nd | 0.20 | C | 2.0 | >99 | 1060 | 113 | 2.4 |
| 14 | 5.0 | Nd | 0.20 | C | 3.0 | >99 | 740 | 88 | 2.3 |
| 15 | 5.0 | W | 0.10 | C | 0.05 | >99 | 1530 | 145 | 3.6 |
| 16 | 5.0 | W | 0.15 | C | 0.05 | >99 | 1380 | 123 | 2.6 |
| 17 | 5.0 | W | 5.00 | C | 0.05 | >99 | 1220 | 78 | 2.2 |
| 18 | 5.0 | W | 7.50 | C | 0.05 | 98 | 1200 | 73 | 2.2 |
| 19 | 5.0 | W | 0.20 | C | 0.0025 | >99 | 1960 | 153 | 3.8 |
| 20 | 5.0 | W | 0.20 | C | 0.005 | >99 | 1360 | 136 | 2.8 |
| 21 | 5.0 | W | 0.20 | C | 2.0 | >99 | 1250 | 120 | 2.4 |
| 22 | 5.0 | W | 0.20 | C | 3.0 | >99 | 1200 | 117 | 2.3 |
| 23 | 5.0 | Sc | 0.10 | C | 0.05 | >99 | 1880 | 430 | 4.5 |
| 24 | 5.0 | Sc | 0.15 | C | 0.05 | >99 | 1620 | 138 | 2.8 |
| 25 | 5.0 | Sc | 5.00 | C | 0.05 | >99 | 1530 | 131 | 2.5 |
| 26 | 5.0 | Sc | 7.50 | C | 0.05 | 97 | 1470 | 124 | 2.4 |
| 27 | 5.0 | Sc | 0.20 | C | 0.0025 | >99 | 2340 | 204 | 3.8 |
| 28 | 5.0 | Sc | 0.20 | C | 0.005 | >99 | 1550 | 133 | 2.6 |
| 29 | 5.0 | Sc | 0.20 | C | 2.0 | >99 | 1480 | 121 | 2.4 |
| 30 | 5.0 | Sc | 0.20 | C | 3.0 | >99 | 1020 | 94 | 2.2 |

TABLE 2

| | | | | | | Structure of extruded material | | | |
|---|---|---|---|---|---|---|---|---|---|
| | | | | | | Parent phase | | | |
| | Composition | | | | | | Average | Particle composed of | |
| | Fe | First element | | Second element | | | crystal grain | compound including Al and Fe | |
| Sample | Content | | Content | | Content | Al ratio | size | Average length | |
| No. | (at %) | | (at %) | | (at %) | (at %) | (nm) | (nm) | Aspect ratio |
| 31 | 1.0 | Nd | 0.20 | B | 0.05 | >99 | 1260 | 52 | 1.9 |
| 32 | 1.2 | Nd | 0.20 | B | 0.05 | >99 | 1300 | 55 | 2.0 |
| 33 | 6.5 | Nd | 0.20 | B | 0.05 | >99 | 1480 | 87 | 2.3 |
| 34 | 8.0 | Nd | 0.20 | B | 0.05 | >99 | 1730 | 140 | 2.9 |
| 35 | 5.0 | Nd | 0.10 | B | 0.05 | >99 | 1770 | 210 | 3.5 |
| 36 | 5.0 | Nd | 0.15 | B | 0.05 | >99 | 1580 | 134 | 3.1 |
| 37 | 5.0 | Nd | 5.00 | B | 0.05 | >99 | 1220 | 40 | 2.3 |
| 38 | 5.0 | Nd | 7.50 | B | 0.05 | 96 | 1130 | 33 | 1.9 |
| 39 | 5.0 | Nd | 0.20 | B | 0.0025 | >99 | 1830 | 320 | 3.8 |
| 40 | 5.0 | Nd | 0.20 | B | 0.005 | >99 | 1660 | 121 | 2.5 |
| 41 | 5.0 | Nd | 0.20 | B | 2.0 | >99 | 895 | 30 | 2.0 |
| 42 | 5.0 | Nd | 0.20 | B | 3.0 | >99 | 840 | 30 | 1.9 |
| 43 | 5.0 | W | 0.10 | B | 0.05 | >99 | 2020 | 241 | 3.7 |
| 44 | 5.0 | W | 0.15 | B | 0.05 | >99 | 1630 | 140 | 3.1 |
| 45 | 5.0 | W | 5.00 | B | 0.05 | >99 | 1360 | 49 | 2.2 |
| 46 | 5.0 | W | 7.50 | B | 0.05 | 96 | 1280 | 43 | 2.1 |
| 47 | 5.0 | W | 0.20 | B | 0.0025 | >99 | 2100 | 368 | 3.6 |
| 48 | 5.0 | W | 0.20 | B | 0.005 | >99 | 1690 | 136 | 2.9 |
| 49 | 5.0 | W | 0.20 | B | 2.0 | >99 | 950 | 40 | 2.3 |
| 50 | 5.0 | W | 0.20 | B | 3.0 | >99 | 920 | 36 | 2.1 |
| 51 | 5.0 | Sc | 0.10 | B | 0.05 | >99 | 1735 | 189 | 2.8 |
| 52 | 5.0 | Sc | 0.15 | B | 0.05 | >99 | 1420 | 112 | 2.5 |
| 53 | 5.0 | Sc | 5.00 | B | 0.05 | >99 | 1100 | 38 | 2.1 |
| 54 | 5.0 | Sc | 7.50 | B | 0.05 | 95 | 1020 | 32 | 2.0 |
| 55 | 5.0 | Sc | 0.20 | B | 0.0025 | >99 | 1710 | 288 | 2.9 |
| 56 | 5.0 | Sc | 0.20 | B | 0.005 | >99 | 1495 | 109 | 2.4 |
| 57 | 5.0 | Sc | 0.20 | B | 2.0 | >99 | 810 | 35 | 2.1 |
| 58 | 5.0 | Sc | 0.20 | B | 3.0 | >99 | 770 | 31 | 2.0 |

TABLE 3

| | Property of extruded material | | | | | | | |
|---|---|---|---|---|---|---|---|---|
| | | | | | | Strength property at high | | |
| | | Strength property at room temperature (25° C.) | | | | temperature (250° C.) | | |
| | | | | | 0.2% proof | | Rate of reduction in | |
| | Relative | Tensile | Elongation | 0.2% proof | stress/tensile | Tensile | strength at | |
| Sample | density | strength | after fracture | stress | strength | strength | 25° C.⇒250° C. | Conductivity |
| No. | (%) | (MPa) | (%) | (MPa) | (%) | (MPa) | (%/° C.) | (% IACS) |
| 1 | 99 | 271 | 10.3 | 157 | 58 | 83 | 0.31 | 52 |
| 2 | 99 | 304 | 9.4 | 221 | 73 | 134 | 0.25 | 48 |
| 3 | 99 | 345 | 9.2 | 294 | 85 | 198 | 0.19 | 45 |
| 4 | 98 | 447 | 8.4 | 415 | 93 | 272 | 0.17 | 32 |
| 5 | 98 | 439 | 6.2 | 428 | 97 | 336 | 0.10 | 27 |
| 6 | 97 | 353 | 1.6 | 183 | 52 | 283 | 0.09 | 24 |
| 7 | 99 | 296 | 8.4 | 178 | 60 | 92 | 0.31 | 35 |
| 8 | 98 | 370 | 7.2 | 285 | 77 | 157 | 0.26 | 31 |
| 9 | 98 | 455 | 4.1 | 425 | 93 | 289 | 0.16 | 26 |
| 10 | 97 | 320 | 0.8 | 193 | 60 | 267 | 0.07 | 22 |
| 11 | 99 | 285 | 8.6 | 170 | 60 | 84 | 0.31 | 33 |
| 12 | 98 | 321 | 7.6 | 257 | 80 | 185 | 0.19 | 32 |
| 13 | 98 | 462 | 3.8 | 450 | 97 | 346 | 0.11 | 32 |
| 14 | 98 | 271 | 0.5 | 155 | 57 | 226 | 0.07 | 30 |
| 15 | 99 | 331 | 6.3 | 192 | 58 | 94 | 0.32 | 34 |
| 16 | 98 | 414 | 5.4 | 303 | 73 | 163 | 0.27 | 29 |
| 17 | 98 | 489 | 3.1 | 459 | 94 | 304 | 0.17 | 26 |
| 18 | 96 | 350 | 0.6 | 200 | 57 | 282 | 0.09 | 21 |
| 19 | 98 | 305 | 6.5 | 183 | 60 | 94 | 0.31 | 32 |
| 20 | 98 | 354 | 5.7 | 282 | 80 | 193 | 0.20 | 30 |
| 21 | 98 | 497 | 3.6 | 463 | 93 | 338 | 0.14 | 29 |
| 22 | 98 | 295 | 0.5 | 157 | 53 | 218 | 0.12 | 28 |
| 23 | 99 | 266 | 9.2 | 155 | 58 | 75 | 0.32 | 30 |
| 24 | 99 | 333 | 7.9 | 248 | 74 | 128 | 0.27 | 29 |
| 25 | 99 | 409 | 4.5 | 366 | 89 | 222 | 0.20 | 26 |
| 26 | 98 | 291 | 0.9 | 171 | 59 | 205 | 0.13 | 23 |
| 27 | 99 | 251 | 9.7 | 143 | 57 | 72 | 0.32 | 30 |
| 28 | 99 | 278 | 8.2 | 220 | 79 | 147 | 0.21 | 29 |
| 29 | 99 | 414 | 4.4 | 379 | 92 | 276 | 0.15 | 25 |
| 30 | 99 | 248 | 0.6 | 133 | 54 | 182 | 0.12 | 19 |

TABLE 4

| | Property of extruded material | | | | | | | |
|---|---|---|---|---|---|---|---|---|
| | | | | | | Strength property at high | | |
| | | Strength property at room temperature (25° C.) | | | | temperature (250° C.) | | |
| | | | | | 0.2% proof | | Rate of reduction in | |
| | Relative | Tensile | Elongation | 0.2% proof | stress/tensile | Tensile | strength at | |
| Sample | (%) | strength | after fracture | stress | strength | strength | 25° C.⇒250° C. | Conductivity |
| No. | density | (MPa) | (%) | (MPa) | (%) | (MPa) | (%/° C.) | (% IACS) |
| 31 | 99 | 311 | 8.9 | 166 | 53 | 85 | 0.32 | 51 |
| 32 | 98 | 349 | 8.1 | 258 | 74 | 141 | 0.26 | 49 |
| 33 | 98 | 495 | 5.3 | 446 | 90 | 348 | 0.12 | 31 |
| 34 | 96 | 400 | 1.4 | 188 | 47 | 297 | 0.11 | 24 |
| 35 | 98 | 331 | 6.8 | 198 | 60 | 97 | 0.31 | 35 |
| 36 | 98 | 414 | 5.9 | 310 | 75 | 166 | 0.27 | 34 |
| 37 | 98 | 490 | 3.4 | 461 | 94 | 309 | 0.16 | 27 |
| 38 | 95 | 362 | 0.7 | 208 | 57 | 284 | 0.10 | 23 |
| 39 | 98 | 309 | 7.0 | 189 | 61 | 88 | 0.32 | 37 |
| 40 | 98 | 337 | 6.2 | 286 | 85 | 195 | 0.19 | 35 |
| 41 | 98 | 493 | 3.1 | 463 | 94 | 360 | 0.12 | 28 |
| 42 | 98 | 295 | 0.5 | 178 | 60 | 243 | 0.08 | 24 |
| 43 | 99 | 287 | 8.2 | 184 | 64 | 80 | 0.32 | 37 |
| 44 | 98 | 360 | 7.1 | 288 | 80 | 161 | 0.25 | 35 |
| 45 | 98 | 432 | 4.1 | 396 | 92 | 290 | 0.15 | 30 |
| 46 | 96 | 320 | 0.9 | 191 | 60 | 258 | 0.09 | 24 |
| 47 | 98 | 268 | 8.4 | 177 | 66 | 73 | 0.32 | 36 |
| 48 | 98 | 293 | 7.6 | 261 | 89 | 188 | 0.16 | 35 |
| 49 | 98 | 450 | 3.8 | 412 | 92 | 343 | 0.11 | 28 |
| 50 | 97 | 255 | 0.8 | 138 | 54 | 230 | 0.04 | 22 |
| 51 | 99 | 344 | 6.3 | 188 | 55 | 84 | 0.34 | 30 |
| 52 | 99 | 425 | 5.3 | 306 | 72 | 170 | 0.27 | 29 |
| 53 | 99 | 501 | 3.9 | 443 | 88 | 302 | 0.18 | 25 |
| 54 | 98 | 377 | 0.7 | 190 | 50 | 275 | 0.12 | 17 |
| 55 | 99 | 320 | 6.6 | 183 | 57 | 75 | 0.34 | 32 |
| 56 | 99 | 359 | 5.8 | 278 | 77 | 201 | 0.20 | 31 |
| 57 | 99 | 504 | 3.0 | 451 | 89 | 359 | 0.13 | 26 |
| 58 | 99 | 303 | 0.6 | 137 | 45 | 244 | 0.09 | 22 |

Hereinafter, among the samples, a sample having a composition in which the content of Fe is no less than 1.2 at % and no more than 6.5 at %, the content of the first element is no less than 0.15 at % and no more than 5 at %, and the content of the second element is no less than 0.005 at % and no more than 2 at %, is referred to as a specific sample group. In Table 1 and Table 3, the specific sample group includes samples No. 2 to No. 5, No. 8, No. 9, No. 12, No. 13, No. 16, No. 17, No. 20, No. 21, No. 24, No. 25, No. 28, and No. 29. In Table 2 and Table 4, the specific sample group includes samples No. 32, No. 33, No. 36, No. 37, No. 40, No. 41, No. 44, No. 45, No. 48, No. 49, No. 52, No. 53, No. 56, and No. 57.

With reference to Table 3 and Table 4, the properties are now focused on.

As shown in Table 3 and Table 4, the specific sample group has higher strength and proof stress at room temperature than the other samples. Quantitatively, the tensile strength at 25° C. is no less than 275 MPa. The 0.2% proof stress at 25° C. is no less than 190 MPa. The specific sample group also has a higher YP value than the other samples. Quantitatively, the YP value is no less than 70%. One of the reasons why the specific sample group has higher strength, proof stress, and YP value at room temperature includes that it has the above-mentioned specific composition. The tensile strength at 25° C. depends on the content of Fe, the content of the first element, and the content of the second element, and is no less than 280 MPa and no less than 300 MPa. The YP value is no less than 75% and no less than 80%. The tensile strength at 25° C. is no less than 350 MPa, and furthermore, some samples have a tensile strength of less than 400 MPa. Some samples have a YP value of no less than 85%. In the above-mentioned specific content range, the higher the content of Fe, the content of the first element, and the content of the second element at room temperature, the higher the tensile strength at room temperature, the 0.2% proof stress at room temperature, and the YP value tend to be.

The specific sample group also has higher tensile strength at 250° C. than the other samples. In other words, the tensile strength of the specific sample group does not easily decrease even when the temperature increases from 25° C. to 250° C. Quantitatively, the rate of reduction in the tensile strength is no more than 0.30%/° C. Such a specific sample group is also excellent in heat resistance. One of the reasons why the specific sample group is excellent in heat resistance is presumed to be that it has the above-mentioned specific composition. The rate of reduction in tensile strength depends on the content of Fe, the content of the first element, and the content of the second element, and is no more than 0.25%/° C. and no more than 0.2%/° C. In the above-mentioned specific content range, the higher the content of Fe, the content of the first element, and the content of the second element, the smaller the rate of reduction of the tensile strength tends to be.

The specific sample group also has an elongation after fracture at 25° C. of no less than 3%. From this point, the specific sample group has not only excellent strength and proof stress at room temperature and but also excellent elongation.

Furthermore, the specific sample group has a conductivity at 25° C. of no less than 25% IACS. From this point, the specific sample group is also excellent in conductive properties. One of the reasons for the excellent conductivity of the specific sample group is presumed to be that the Al ratio in the parent phase is as high as no less than 99 at %. In such a parent phase, the additive elements do not substantially form a solid solution in Al. Therefore, the reduction in conductivity caused by the solid solution of the additive elements is presumed to have been inhibited. This is also confirmed by the fact that samples No. 10, No. 18, and No. 26 with an Al ratio of no more than 98 at % have a conductivity of no more than 23% IACS.

With reference to Table 1 and Table 2, the texture is then focused on.

As shown in Table 1 and Table 2, in the specific sample group, the crystal grains have an average grain size of no more than 1,700 nm and the compound particles have an average length of no more than 140 nm. Such a specific sample group has a texture in which the fine compound particles are dispersed in the fine crystal texture. The specific sample group, in addition to the above-mentioned specific composition, is presumed to have such a specific texture that the strength, proof stress, and YP value at room temperature have been enhanced by dispersion strengthening of the compound particles and by grain boundary strengthening of the crystal grains.

In the specific sample group, the compound particles have an aspect ratio of no more than 3.5. Such compound particles are not needle-like, but almost spherical. The compound particles that are almost spherical are presumed to have improved strength and proof stress at room temperature since they do not easily become a starting point of cracking. In addition, the elongation at room temperature is also presumed to have been improved. Furthermore, the compound particles that are almost spherical do not easily interfere with the conductive path of Al. From this fact, the conductive properties are presumed to be easily improved.

Furthermore, the tensile strength of the specific sample group does not easily decrease even at a high temperature of 250° C. From this fact, the above-mentioned specific composition is presumed to make it easier to maintain the state in which the fine compound particles are dispersed in the above-mentioned fine crystal texture even at the above high temperature.

Although hot working and heat treatment are performed in the production process, the composition has the above-mentioned specific fine structure after heat treatment. From this fact, the above-mentioned specific composition is presumed to make it easier to maintain the finesse of the compound particles especially.

In this test, the fineness of the compound particles is presumed to result in a tendency for the crystal grains to become finer. In order to enhance tensile strength and proof stress, the increase of second elements such as C is presumed to tend to be more effective than the increase of Fe and the increase of first elements such as Nd.

Moreover, the specific sample group has a relative density as high as no less than 98% and is dense. Since fracture due to voids and the like do not easily occur, the specific sample group is also presumed to be excellent in strength. Since extruded materials with high relative density are obtained in the production process, the specific sample group is also excellent in manufacturability.

From the above, it has been shown that the aluminum alloy material formed of an aluminum alloy including Fe, the first element, and the second element in the above-mentioned specific range is excellent in strength and proof stress at room temperature. It has also been shown that the aluminum alloy material is also excellent in heat resistance. In particular, the aluminum alloy material has good heat resistance when the crystals forming the parent phase are fine and the fine compound particles are dispersed in this parent phase.

Furthermore, it has been shown that the above-mentioned aluminum alloy material having excellent proof stress can be produced by preparing a dense intermediate material using a powder or the like produced through quenching of molten metal, subjecting the intermediate material to plastic working or the like under heating to a predetermined temperature, and further subjecting it to heat treatment.

The present invention is not limited to these examples but indicated by the claims and is intended to include all modifications within the meaning and scope that are equivalent to the claims.

For example, in Test Example 1, the content of Fe, the content of the first element, the content of the second element, the production conditions, the shape and dimensions of the aluminum alloy material and the like can be modified. Examples of the production conditions include the cooling rate of molten metal, the working temperature and applied pressure during forming, and the heating temperature and holding time during heat treatment.

### REFERENCE SIGNS LIST

1 compound particle
P1, P2 parallel line
L1 maximum length

1. An aluminum alloy material comprising a composition comprising:
no less than 1.2 at % and no more than 6.5 at % of Fe,
no less than 0.15 at % and no more than 5 at % of at least one first element selected from the group consisting of Nd, W, and Sc, and
no less than 0.005 at % and no more than 2 at % of at least one second element selected from the group consisting of C and B, the balance being Al and inevitable impurities.

2. The aluminum alloy material according to claim 1, wherein
the aluminum alloy material comprises a structure comprising a parent phase having no less than 99 at % of Al and particles that are present in the parent phase and formed of a compound comprising Al and Fe, and wherein
in a cross section thereof, crystal grains constituting the parent phase have an average grain size of no more than 1.700 nm, and the particles have an average length of no more than 140 nm.

3. The aluminum alloy material according to claim 2, wherein the particle has an aspect ratio of no more than 3.5.

4. The aluminum alloy material according to claim 1, wherein the aluminum alloy material has a tensile strength of no less than 275 MPa at 25° C.

5. The aluminum alloy material according to claim 1, wherein a 0.2% proof stress value at 25° C. is no less than 70% of a tensile strength value at 25° C.

6. The aluminum alloy material according to claim 1, wherein a rate of reduction in tensile strength, as determined from the tensile strength value at 25° C. and a tensile strength value at 250° C., is no more than 0.30%/° C.

7. The aluminum alloy material according to claim 1, wherein the aluminum alloy material has an elongation after fracture of no less than 3% at 25° C.

8. The aluminum alloy material according to claim 1, wherein the aluminum alloy material has a conductivity of no less than 25% IACS at 25° C.
